(19) United States
(12) Patent Application Publication
(10) Pub. No.: US 2023/0204751 A1
(43) Pub. Date: Jun. 29, 2023

(54) OBJECT DETECTION DEVICE, RADAR DEVICE, AND OBJECT DETECTION METHOD

(71) Applicant: Mitsubishi Electric Corporation, Tokyo (JP)

(72) Inventors: Yu SHIMIZU, Tokyo (JP); Satoshi KAGEME, Tokyo (JP); Takayuki KITAMURA, Tokyo (JP); Kei SUWA, Tokyo (JP)

(73) Assignee: Mitsubishi Electric Corporation, Tokyo (JP)

(21) Appl. No.: 18/178,340

(22) Filed: Mar. 3, 2023

Related U.S. Application Data
(63) Continuation of application No. PCT/JP2020/037818, filed on Oct. 6, 2020.

(51) Int. Cl. G01S 13/52; G01S 13/931; G01S 7/03; G01S 13/42; G01S 13/58

(52) U.S. Cl. CPC G01S 13/52; G01S 13/931; G01S 7/03; G01S 13/42; G01S 13/589; G01S 2013/932

(57) ABSTRACT

An object detection device includes processing circuitry configured to acquire wave data; acquire the moving velocity of a radar device; estimate a relative distance between the radar device and a target, angle of incidence of a reflection signal from the target, and a first relative velocity between the radar device and the target, by using the wave data; and estimate a second relative velocity between the radar device and the target in a case where the target is a static object, on the basis of the acquired moving velocity and the relative distance and the angle of incidence, and determine whether the target is a static object by comparing the first relative velocity and the second relative velocity.

### CROSS REFERENCE TO RELATED APPLICATIONS

This application is a Continuation of PCT International Application No. PCT/JP2020/037818, filed on Oct. 6, 2020, all of which is hereby expressly incorporated by reference into the present application.

### TECHNICAL FIELD

The present disclosure relates to an object detection device, a radar device, and an object detection method.

### BACKGROUND ART

Vehicle-mounted radar devices emits an electric wave, e.g., a millimeter wave, to outside a vehicle, receive a reflected wave of the electric wave, the reflected wave being reflected by a target present outside the vehicle, and analyzes a reception signal which is generated using the received electric wave, thereby calculating the relative distances and the relative velocities between the target and the vehicle-mounted radar devices. Objects observed by vehicle-mounted radar devices include not only moving objects such as pedestrians, but also static objects such as guardrails. Vehicle-mounted radar devices need to determine in advance whether an object observed thereby is a moving object such as a pedestrian who might run out from a road shoulder toward a vehicle.

For vehicle-mounted radar devices, an object detection device for and an object detection method of determining whether an object observed is either a static object or a moving object are used. For example, in Patent Literature 1, an object detection device for and an object detection method of performing an analysis on a reception signal of an electric wave emitted from a radar device and then reflected by an object, using a multipath environment model which shows the path of a reflected wave of an electric wave, the reflected wave being reflected by a static object, and a non-multipath environment model which shows the path of a reflected wave which is not under a multipath environment, thereby determining whether the reception signal is from a static object are described.

### CITATION LIST

### Patent Literature

Patent Literature 1: JP 2019-20158 A

### SUMMARY OF INVENTION

### Technical Problem

The object detection device described in Patent Literature 1 determines whether the target is a static object on the basis of differences, in the relative distance to the target and in the angle of incidence of the electric wave reflected by the target, between the case in which the target is a moving object and the case in which the target is a static object. Therefore, a problem with the conventional object detection device is that when a moving object and a static object having equal relative distances and equal angles of incidence are included in the target, it is impossible to correctly determine whether the target is a static object.

The present disclosure is made to solve the above-mentioned problem, and it is therefore an object of the present disclosure to provide an object detection device, a radar device, and an object detection method capable of determining whether a target is a static object even in a case where a moving object and a static object having equal relative distances and equal angles of incidence are included in the target.

### Solution to Problem

The object detection device according to the present disclosure includes processing circuitry configured to acquire wave data provided from a radar device that observes a target within an observation time period during which velocity resolution is less than an average moving velocity of a moving object; acquire a moving velocity of the radar device; estimate a relative distance between the radar device and the target, angle of incidence of a signal incident upon the radar device, the signal being emitted from the radar device and reflected by the target, and a first relative velocity between the radar device and the target, by using the wave data; and estimate a second relative velocity between the radar device and the target in a case where the target is a static object, on a basis of the acquired moving velocity and the relative distance and the angle of incidence which have been estimated, and configured to determine whether the target is a static object by comparing the first relative velocity and the second relative velocity.

### Advantageous Effects of Invention

According to the present disclosure, it is possible to use the wave data which the radar device acquires by observing the target within the observation time period during which the speed resolution is smaller than the average moving velocity of moving objects, thereby estimating the second relative velocity in a case where the target is a static object, on the basis of the moving velocity of the radar device, the relative distance between the radar device and the target, and the angle of incidence with which the signal emitted from the radar device and reflected by the target is incident upon the radar device. As a result, the object detection device according to the present disclosure can determine whether the target is a static object even in a case where a moving object and a static object having equal relative distances and equal angles of incidence are included in the target being observed by the radar device.

### BRIEF DESCRIPTION OF DRAWINGS

FIG. 1 is a block diagram showing the configuration of a radar device according to Embodiment 1;

FIG. 2 is a flowchart showing the operation of an object detection device according to Embodiment 1;

FIG. 3 is a flowchart showing the details of a process in step ST2 of FIG. 1;

FIG. 4 is a flowchart showing the details of a process in step ST3 of FIG. 1;

FIG. 5 is an outline diagram showing a relation between the radar device and a moving object;

FIG. 6 is an outline diagram showing a relation between the radar device and a static object;

FIG. 7 is a flowchart showing the details of a process in step ST4 of FIG. 1;

FIG. 8 is an outline diagram showing a positional relationship between the radar device and the target when there is no possibility that the target collides with the radar device;

FIG. 9 is an outline diagram showing a positional relationship between the radar device and the target when there is a possibility that the target collides with the radar device;

FIG. 10 is an outline diagram showing a positional relationship between a predicted line which is a quadratic curve and the radar device; and

FIG. 11A is a block diagram showing a hardware configuration for implementing the functions of the object detection device according to Embodiment 1, and FIG. 11B is a block diagram showing a hardware configuration for executing software which implements the functions of the object detection device according to Embodiment 1.

### DESCRIPTION OF EMBODIMENTS

### Embodiment 1

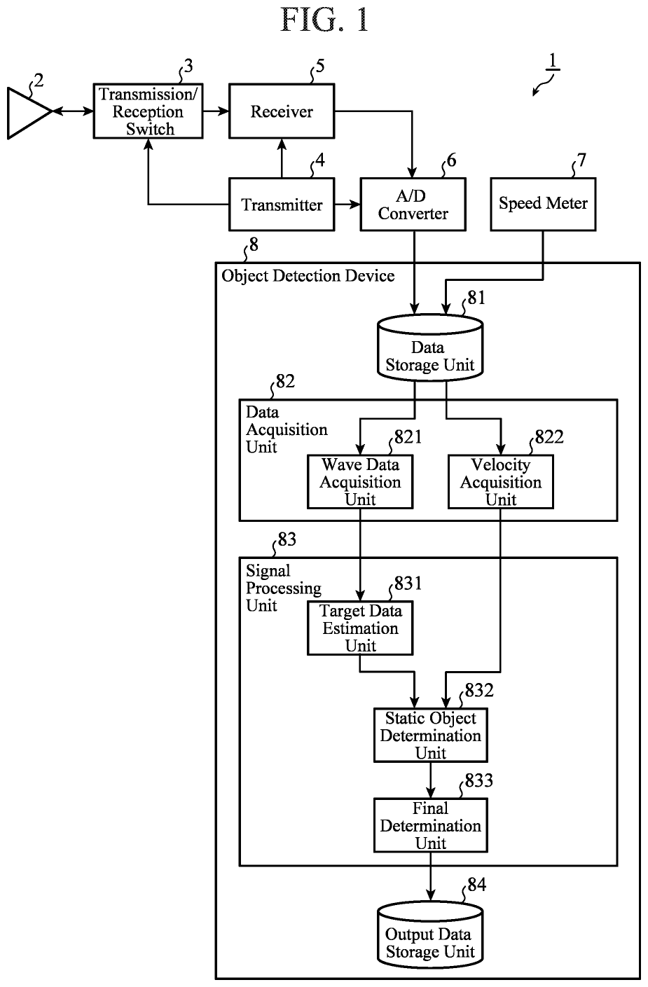

FIG. 1 is a block diagram showing the configuration of a radar device 1 according to Embodiment 1. The radar device 1 is mounted in, for example, a movable body, and emits an electromagnetic wave to outside the movable body, receives a reflected wave resulting from the reflection of the electromagnetic wave from a target, and observes the target on the basis of a reception signal of the reflected wave. In the following explanation, the movable body is assumed to be a vehicle. As shown in FIG. 1, the radar device 1 includes an antenna 2, a transmission/reception switch 3, a transmitter 4, a receiver 5, an A/D converter 6, a velocity meter 7, and an object detection device 8.

The antenna 2 is a transmission and reception antenna that is connected to the transmission/reception switch 3, and that transmits a transmission RF signal which is an electromagnetic wave and receives a reception RF signal which is a reflected wave from a target. The type of the antenna 2 is selected depending on, for example, the environment where the radar device 1 is used. For example, the type of the antenna 2 includes a patch antenna or a horn antenna. Further, the antenna 2 may be an array antenna which includes multiple element antennas. In the following explanation, the antenna 2 is assumed to be an array antenna. The transmission/reception switch 3 switches, in time sequence, between a transmission timing when the transmission RF signal is outputted to the antenna 2, and a reception timing when the antenna 2 receives a reflected wave reflected from a target.

The transmitter 4 performs pulse modulation on the transmission RF signal, and outputs the transmission RF signal on which the pulse modulation is performed to the transmission/reception switch 3 and the A/D converter 6. The transmission RF signal is emitted to space by the antenna 2 in a state where the transmission/reception switch 3 is made to switch to a transmission mode. The receiver 5 receives, as a reception RF signal, a signal containing a reflection signal resulting from the reflection of the transmission RF signal from a target in a state where the transmission/reception switch 3 is made to switch to a reception mode.

The transmitter 4 and the receiver 5 are set up in such a way that a target is observed within an observation time period during which the speed resolution of the radar device 1 is smaller than the average moving velocity of moving objects. For example, when the moving objects are assumed to be pedestrians, an observation time period during which the speed resolution of the radar device 1 is smaller than the average moving velocity of pedestrians is set to the transmitter 4 and the receiver 5. When the movable body in which the radar device 1 is mounted is a vehicle, vehicles, bicycles, animals or the likes, other than pedestrians, are cited as the assumed moving objects. The average moving velocity of moving objects is calculated on the basis of, for example, statistical data about movements of moving objects, and is preset to the radar device 1.

The A/D converter 6 A/D converts each of the following signals: the transmission RF signal generated by the transmitter 4 and the reception RF signal received by the receiver 5, and outputs A/D converted signals to the object detection device 8. The velocity meter 7 measures the moving velocity of the radar device 1. For example, when the radar device 1 is mounted in a vehicle, the velocity meter 7 measures the absolute velocity of the radar device 1 which is based on the moving velocity of the vehicle.

The object detection device 8 determines whether or not a target which the radar device 1 is observing is a static object, and includes a data storage unit 81, a data acquisition unit 82, a signal processing unit 83, and an output data storage unit 84. The data storage unit 81 is configured in a storage device which the object detection device 8 includes. In the data storage unit 81, the reception RF signal outputted from the A/D converter 6 is stored as wave data and the moving velocity of the radar device 1 measured by the velocity meter 7 is stored as velocity data. The data storage unit 81 may be configured in a storage device disposed separately from the object detection device 8.

The data acquisition unit 82 acquires the wave data and the velocity data which are used for the determination as to whether or not the target observed by the radar device 1 is a static object, out of the pieces of data stored in the data storage unit 81. For example, in a case where the data storage unit 81 is configured in a storage device disposed separately from the object detection device 8, the data acquisition unit 82 acquires the wave data and the moving velocity data from the above-mentioned storage device via a wired or wireless communication path. As shown in FIG. 1, the data acquisition unit 82 includes a wave data acquisition unit 821 and a velocity acquisition unit 822.

The wave data acquisition unit 821 acquires the wave data from the pieces of data stored in the data storage unit 81. The wave data is data which the radar device 1 acquires by observing the target within the observation time period during which the speed resolution is smaller than the average moving velocity of moving objects, and which is related to complex numbers acquired through multiple hits by the transmitter 4 and the receiver 5, each data containing a reception RF signal of a reflection signal from the target. The velocity acquisition unit 822 acquires the velocity data showing the moving velocity of the radar device 1 from the pieces of data stored in the data storage unit 81.

The signal processing unit 83 determines whether or not the target observed by the radar device 1 is a static object by performing signal processing which uses the wave data and the velocity data which are acquired by the data acquisition unit 82, and, in a case where the target is a moving object, determines whether or not there is a possibility that the vehicle in which the radar device 1 is mounted collides with the target. Further, the output data storage unit 84 is configured in a storage device which the object detection device 8 includes. Data acquired through the signal processing by the signal processing unit 83 is stored, as output data, in the output data storage unit 84. The output data storage unit 84 may be configured in a storage device disposed separately from the object detection device 8.

The signal processing unit 83 shown in FIG. 1 includes a target data estimation unit 831, a static object determination unit 832, and a final determination unit 833. The target data estimation unit 831 estimates the relative distance between the radar device 1 and the target, the angle of incidence of the reception RF signal, and the relative velocity between the radar device 1 and the target, using the wave data acquired by the wave data acquisition unit 821.

The relative distance of the radar device 1 and the target is the one between the radar device 1 moving together with the vehicle, and the target observed by the radar device 1. The angle of incidence of the reception RF signal is the one at a time when the signal emitted from the radar device 1 and reflected by the target is incident upon the radar device 1, and is, for example, the angle which the direction of movement of the radar device 1 forms with the reception direction of the reflection signal from the target. Further, the relative velocity between the radar device 1 and the target is a first relative velocity showing the relative velocity between the radar device 1 and the target.

The static object determination unit 832 estimates the relative velocity between the target and the radar device 1 in a case where the target is a static object, on the basis of the velocity data acquired by the velocity acquisition unit 822, and the relative distance and the angle of incidence which are estimated by the target data estimation unit 831. The static object determination unit 832 determines whether or not the target is a static object by comparing the relative velocity estimated thereby and the relative velocity estimated by the target data estimation unit 831. The relative velocity between the target and the radar device 1 in a case where the target is a static object is the one of the radar device 1 with respect to the target which is a static object, and is a second relative velocity.

The final determination unit 833 determines whether or not there is a possibility that the target collides with the radar device 1. For example, the wave data acquisition unit 821, the velocity acquisition unit 822, the target data estimation unit 831, and the static object determination unit 832 repeatedly perform their respective processes in multiple cycles. The final determination unit 833 estimates the direction of movement of the target using velocity vectors of the target, the velocity vectors being acquired through the determination in the multiple cycles by the static object determination unit 832, and determines whether or not there is a possibility that the target collides with the radar device 1 on the basis of the target's direction of movement estimated thereby. A result of the determination by the final determination unit 833 is stored in the output data storage unit 84.

In the case where the output data storage unit 84 is configured in a storage device disposed separately from the object detection device 8, the final determination unit 833 outputs data showing the determination result to the storage device via a wired or wireless communication path. Further, in a case where the object detection device 8 performs only the determination of whether or not the target observed by the radar device 1 is a static object, the final determination unit 833 is omitted from the components of the object detection device 8.

The operation of the object detection device 8 according to Embodiment 1 is as follows.

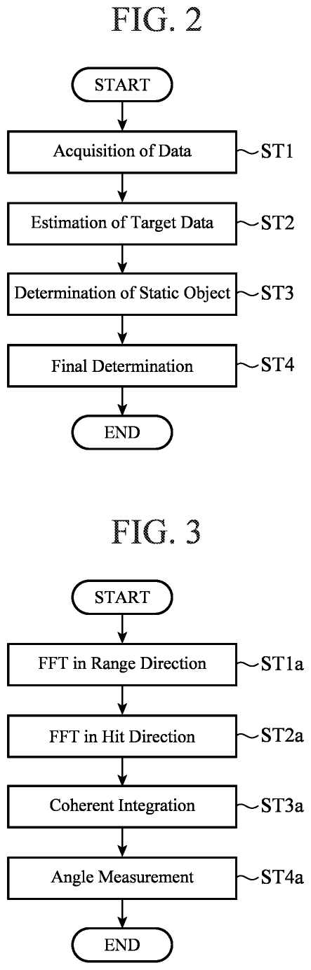

FIG. 2 is a flowchart showing the operation of the object detection device 8. Processes in steps ST1 to ST3 in FIG. 2 show an object detection method according to Embodiment 1.

The data acquisition unit 82 acquires the wave data and the velocity data from the pieces of data stored in the data storage unit 81 (step ST1). For example, the wave data acquisition unit 821 acquires the wave data about multiple hits from the data storage unit 81. In addition, the speed acquisition unit 822 acquires the velocity data about the radar device 1 at the same time as the observation time of the wave data which the wave data acquisition unit 821 has acquired from the data storage unit 81. The velocity data acquired by the velocity acquisition unit 822 is outputted to the static object determination unit 832.

The number of hits of the wave data which the wave data acquisition unit 821 acquires may be the one which is counted within the observation time period during which speed resolution Δvᵣₑₛₒ expressed by the following equation (1) is smaller than the average moving velocity of moving objects. In the following equation (1), λ is the wavelength of an electromagnetic wave transmitted per one hit by the transmitter 4 and received per one hit by the receiver 5. T_{obs} is the time period during which the target is observed by the radar device 1. The observation time period T_{obs} may be a total time acquired by performing an addition of each observation time period of the target per one hit multiple times corresponding to multiple hits. For example, when the moving objects are assumed to be pedestrians and the average walking speed of pedestrians is v_{ped}, the wave data acquisition unit 821 acquires the wave data within the observation time period T_{obs} during which the speed resolution Δvᵣₑₛₒ is smaller than the speed v_{ped}. The wave data acquired by the wave data acquisition unit 821 is outputted to the target data estimation unit 831.

$$Δ {v}_{reso} = \frac{λ}{2 {T}_{obs}} \qquad ( 1 )$$

Next, the target data estimation unit 831 estimates target data showing the relative distance, relative velocity, and angle of incidence with respect to the target observed by the radar device 1, using the wave data acquired by the wave data acquisition unit 821 (step ST2). FIG. 3 is a flowchart showing the details of the process of step ST2 of FIG. 1, and shows the process of estimating the target data which is performed by the target data estimation unit 831. The target data estimation unit 831 calculates relative distance γ′_{tgt} between the radar device 1 and the target by performing a fast Fourier transform (FFT) in range direction on the wave data (step ST1a). The target data estimation unit 831 may calculate the relative distance γ′_{tgt} by performing a digital Fourier transform (DFT) in range direction, instead of the FFT, on the wave data.

Next, the target data estimation unit 831 calculates the relative velocity v′_{tgt} of the moving velocity between the radar device 1 and the velocity of the target in a line-of-sight direction by performing an FFT in hit direction on the wave data (step ST2a). The target data estimation unit 831 may calculate the relative velocity v′_{tgt} by performing a DFT in hit direction, instead of the FFT, on the wave data. In a case where the target is a moving object, the line-of-sight direction of the target is the direction in which the moving object is moving.

The target data estimation unit 831 performs coherent integration on the reception signal of each of the multiple element antennas which constitute the antenna 2, the reception signal being contained in the wave data (step ST3a). The target data estimation unit 831 uses, for example, constant false alarm rate (CFAR) processing, thereby detecting the target in the direction of the angle of incidence of the reception RF signal on the basis of the received strength of the signal after the coherent integration. In this processing, the target data estimation unit 831 may use the relative distance γ′_{tgt} with respect to the target, which is estimated in step ST1a, and the relative distance with respect to an object near the target, or may use only the relative velocity v′_{tgt} with respect to the target, which is estimated in step ST2a, and the relative velocity with respect to the object near the target.

Next, the target data estimation unit 831 estimates the angle of incidence θ_{tgt} of the reflection signal from the target by performing monopulse angle measurement processing on the data related to the target detected in step ST3a (step ST4a). The target data estimation unit 831 may estimate the angle of incidence θ_{tgt} using, for example, angle measurement processing such as multiple signal classification (MUSIC) instead of the monopulse angle measurement processing. The relative distance γ′_{tgt} between the radar device 1 and the target, the relative velocity v′_{tgt} between the radar device 1 and the target, and the angle of incidence θ_{tgt} of the reflection signal from the target, which are estimated by the target data estimation unit 831, are outputted to the static object determination unit 832.

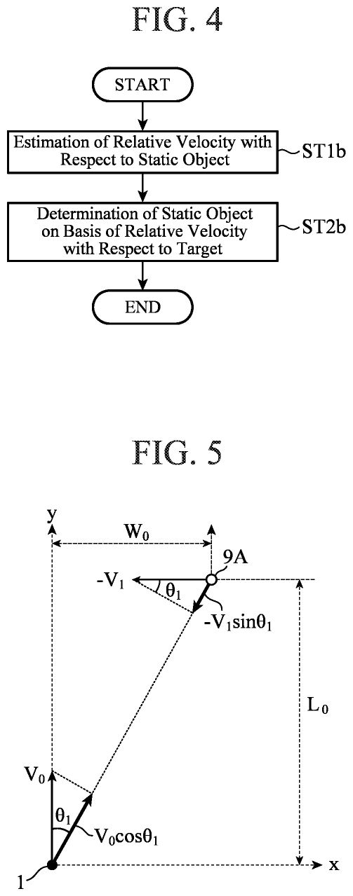

In FIG. 2, the static object determination unit 832 estimates the relative velocity V′_{2, estimation} between the target and the radar device 1 in a case where the target is a static object, on the basis of the velocity V₀ of the radar device 1, the relative distance γ′_{tgt}, and the angle of incidence θ_{tgt}, and determines whether or not the target is a static object by comparing the relative velocity V′_{2, estimation} estimated thereby and the relative velocity v′_{tgt} (step ST3). FIG. 4 is a flowchart showing the details of the process in step ST3 of FIG. 1, and shows static object determination processing by the static object determination unit 832.

The static object determination unit 832 estimates the relative velocity V′_{2, estimation} between the radar device 1 and the target in a case where the target is a static object, using the velocity V₀ of the radar device 1, the relative distance γ′_{tgt} with respect to the target, and the angle of incidence θ_{tgt} of the reflection signal from the target (step ST1b). FIG. 5 is an outline diagram showing a relation between the radar device 1 and a moving object 9A. For example, when the radar device 1 moves at a velocity V₀, and the target is the moving object 9A moving in a direction (x direction) perpendicular to the traveling direction (y direction) of the radar device 1, as shown in FIG. 5, relative velocity V′₁(t) between the radar device 1 and the moving object 9A can be calculated from the following equation (2), using a crossing velocity V₁ of the moving object 9A, and the angle of incidence θ₁ of the reflection signal from the moving object to the radar device 1.

V′₁(t)=V₀ cos θ₁−V₁ sin θ₁ (2)

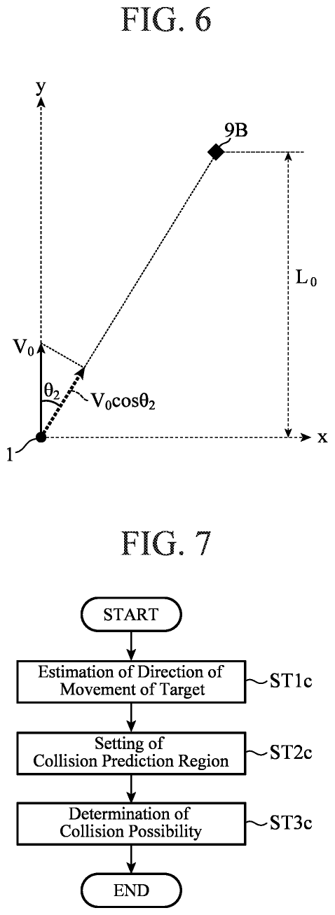

FIG. 6 is an outline diagram showing a relation between the radar device 1 and a static object 9B. In FIG. 6, the radar device 1 moves toward the y direction at the velocity V₀, like that shown in FIG. 5, and the target is the static object 9B. In this case, the static object 9B does not have a velocity V₂. Therefore, the relative velocity V′₂(t) of the radar device 1 and the static object 9B can be calculated from the following equation (3), using the angle of incidence θ₂ of the reflection signal from the static object 9B to the radar device 1.

V′₂(t)=V₀ cos θ₂ (3)

When calculating the relative velocity V′_{2, estimation} between the radar device 1 and the moving object 9A using the above-mentioned equation (2), the crossing velocity V₁ of the moving object 9A is needed. In contrast, in the case where the target is the static object 9B, relative velocity V′₂(t) between the radar device 1 and the static object 9B can be calculated by using the velocity V₀ of the radar device 1 and the angle of incidence θ₂, as is clear from the above equation (3).

The angle of incidence θ_{tgt}(t) of the reflection signal from the target to the radar device 1 varies from moment to moment depending on the positional relationship between the radar device 1 and the target, in accordance with, for example, the following equation (4). In the following equation (4), x(t) is the distance to the target in a direction perpendicular to the traveling direction of the radar device 1. y(t) is the distance to the target in a direction horizontal to the traveling direction of the radar device 1. For example, x(t) is W₀ and y(t) is L₀ as shown in FIG. 5.

$${θ}_{tgt} ( t ) = {tan}^{- 1} ( \frac{x ( t )}{y ( t )} ) \qquad ( 4 )$$

x(t) and y(t) vary with a time t depending on the traveling direction or the traveling velocity of the radar device 1 or the target, as shown in the following equations (5). In the following equations (5), W₀ is the initial distance to the target in a direction perpendicular to the traveling direction of the radar device 1. L₀ is the initial distance to the target in a direction horizontal to the traveling direction of the radar device 1. V_{tgt} is the crossing velocity of the target and is 0 m/s in a case where the target is a static object.

x(t)=W₀−V_{tgt}t

y(t)=L₀−V₀t (5)

The static object determination unit 832 estimates the relative velocity V′_{2, estimation} between the radar device 1 and the static object, using the above-mentioned equations (3), (4), and (5). For example, the static object determination unit 832 sets the distance to the target in a direction perpendicular to the traveling direction of the radar device 1 to an arbitrary value, sets the distance to the target in a direction horizontal to the traveling direction of the radar device 1 to an arbitrary value, and calculates an estimated value of the relative velocity between the radar device 1 and the static object using matrices W and L in which multiple setting values having arbitrary intervals associated with those distances are defined as elements, as shown in the following equation (6). In the following equation (6), a bold character L denotes the matrix L, and the number of setting values of the matrix L is N. A bold character W denotes the matrix W, and the number of setting values of the matrix W is M. ΔL and ΔW are the arbitrary intervals for their setting values. For example, when ΔL and ΔW are set to 10 cm, it is possible to calculate the estimated value of the relative velocity between the radar device 1 and the static object with 10 cm accuracy.

$$L = [ \begin{matrix}{L}_{1 , 1} & {L}_{1 , 2} & ⋯ & {L}_{1 , M} \\ {L}_{2 , 1} & {L}_{2 , 2} & ⋯ & {L}_{2 , M} \\ ⋮ & ⋮ & ⋮ & ⋮ \\ {L}_{N , 1} & {L}_{N , 2} & ⋯ & {L}_{N , M}\end{matrix} ] , W = [ \begin{matrix}{W}_{1 , 1} & {W}_{1 , 2} & ⋯ & {W}_{1 , M} \\ {W}_{2 , 1} & {W}_{2 , 2} & ⋯ & {W}_{2 , M} \\ ⋮ & ⋮ & ⋮ & ⋮ \\ {W}_{N , 1} & {W}_{N , 2} & ⋯ & {W}_{N , M}\end{matrix} ] \qquad ( 6 )$$

$$\{ \begin{matrix}{L}_{n , m} = {L}_{0} - Δ L ( n - 1 ) & ( n = 1 , 2 , ⋯ , N , m = 1 , 2 , ⋯ , M ) \\ {W}_{n , m} = {W}_{0} - Δ W ( m - 1 ) & ( n = 1 , 2 , ⋯ , N , m = 1 , 2 , ⋯ , M )\end{matrix}$$

Using the matrices L and W shown in the above-mentioned equation (6), the static object determination unit 832 can calculate the relative distance R′ between the radar device 1 and the static object from the following equation (7). In the following equation (7), the relative distance R′ is expressed by a matrix including the matrices L and W.

$$\begin{matrix}{R}^{′} = \sqrt{{x ( t )}^{2} + {y ( t )}^{2}} = \sqrt{{W}^{2} + {( L - {V}_{0} t )}^{2}} \\ = \sqrt{[ \begin{matrix}{W}_{1 , 1}^{2} & {W}_{1 , 2}^{2} & ⋯ & {W}_{1 , M}^{2} \\ {W}_{2 , 1}^{2} & {W}_{2 , 2}^{2} & ⋯ & {W}_{2 , M}^{2} \\ ⋮ & ⋮ & ⋮ & ⋮ \\ {W}_{N , 1}^{2} & {W}_{N , 2}^{2} & ⋯ & {W}_{N , M}^{2}\end{matrix} ] + [ \begin{matrix}{( {L}_{1 , 1} - {V}_{0} t )}^{2} & {( {L}_{1 , 2} - {V}_{0} t )}^{2} & ⋯ & {( {L}_{1 , M} - {V}_{0} t )}^{2} \\ {( {L}_{2 , 1} - {V}_{0} t )}^{2} & {( {L}_{2 , 2} - {V}_{0} t )}^{2} ` & ⋯ & {( {L}_{2 , M} - {V}_{0} t )}^{2} \\ ⋮ & ⋮ & ⋮ & ⋮ \\ {( {L}_{N , 1} - {V}_{0} t )}^{2} & {( {L}_{N , 2} - {V}_{0} t )}^{2} & ⋯ & {( {L}_{N , M} - {V}_{0} t )}^{2}\end{matrix} ]}\end{matrix} \\ \{ \begin{matrix}{L}_{n , m} = {L}_{0} - Δ L ( n - 1 ) & ( n = 1 , 2 , ⋯ , N , m = 1 , 2 , ⋯ , M ) \\ {W}_{n , m} = {W}_{0} - Δ W ( m - 1 ) & ( n = 1 , 2 , ⋯ , N , m = 1 , 2 , ⋯ , M )\end{matrix} \qquad ( 7 )$$

Next, the static object determination unit 832 calculates an estimated value of a time-dependent variation in the angle of incidence θ_{2, estimation}(t) of the reflection signal from the static object to the radar device 1 using the above-mentioned equations (4) to (7), in accordance with the following equation (8). In the following equation (8), a bold character R is a matrix in which setting values of the relative distance R′ are defined as elements.

$$\begin{matrix}{θ}_{2 , estimation} ( t ) = {tan}^{- 1} ( \frac{W}{R - {V}_{0} t} ) \\ = {tan}^{- 1} ( \frac{[ \begin{matrix}{W}_{1 , 1} & {W}_{1 , 2} & ⋯ & {W}_{1 , M} \\ {W}_{2 , 1} & {W}_{2 , 2} & ⋯ & {W}_{2 , M} \\ ⋮ & ⋮ & ⋮ & ⋮ \\ {W}_{N , 1} & {W}_{N , 2} & ⋯ & {W}_{N , M}\end{matrix} ]}{[ \begin{matrix}{R}_{1 , 1} & {R}_{1 , 2} & ⋯ & {R}_{1 , M} \\ {R}_{2 , 1} & {R}_{2 , 2} & ⋯ & {R}_{2 , M} \\ ⋮ & ⋮ & ⋮ & ⋮ \\ {R}_{N , 1} & {R}_{N , 2} & ⋯ & {R}_{N , M}\end{matrix} ] - {V}_{0} t} ) \\ = {tan}^{- 1} ( [ \begin{matrix}\frac{{W}_{1 , 1}}{{R}_{1 , 1} - {V}_{0} t} & \frac{{W}_{1 , 2}}{{R}_{1 , 2} - {V}_{0} t} & ⋯ & \frac{{W}_{1 , M}}{{R}_{1 , M} - {V}_{0} t} \\ \frac{{W}_{2 , 1}}{{R}_{2 , 1} - {V}_{0} t} & \frac{{W}_{2 , 2}}{{R}_{2 , 2} - {V}_{0} t} & ⋯ & \frac{{W}_{2 , M}}{{R}_{2 , M} - {V}_{0} t} \\ ⋮ & ⋮ & ⋮ & ⋮ \\ \frac{{W}_{N , 1}}{{R}_{N , 1} - {V}_{0} t} & \frac{{W}_{N , 2}}{{R}_{N , 2} - {V}_{0} t} & ⋯ & \frac{{W}_{N , M}}{{R}_{N , M} - {V}_{0} t}\end{matrix} ] )\end{matrix} \qquad ( 8 )$$

The static object determination unit 832 calculates an estimated value of the relative velocity V′_{2, estimation} between the target and the radar device 1 in a case where the target is a static object, using the angle of incidence θ_{2, estimation}(t), in accordance with the following equation (9).

V′_{2,estimation}(t)=V₀ cos(tan⁻¹(θ_{2,estimation}(t))) (9)

In FIG. 4, the static object determination unit 832 determines whether or not the target is a static object by comparing the relative velocity V′_{2, estimation} with respect to the static object, and the relative velocity v′_{tgt} between the radar device 1 and the target, the relative velocity being estimated by the target data estimation unit 831 (step ST2b). In accordance with the following equation (10), the static object determination unit 832 determines whether or not the target is a static object by comparing the relative velocity V′_{2, estimation}(t) and the relative velocity v′_{tgt}. In the following equation (10), γ_{obj} is a value showing the determination. V_{margin} is a margin of the relative velocity. An arbitrary value for avoiding ambiguity from the determination is set to the relative velocity margin V_{margin}.

$${γ}_{obj} = \{ \begin{matrix}1 , if ( {v}_{tgt}^{′} \geq {V}_{2 , estimation}^{′} ( t ) + {V}_{margin} ) \\ 0 , if ( {v}_{tgt}^{′} < {V}_{2 , estimation}^{′} ( t ) + {V}_{margin} )\end{matrix} \qquad ( 10 )$$

In the determination using the above-mentioned equation (10), the determination result γ_{obj} is “1” in a case where the target is a static object, whereas the determination result γ_{obj} is “0” in a case where the target is a moving object. The series of processes of steps ST1 to ST3 of FIG. 2 is the object detection method according to Embodiment 1. When the determination of whether or not the target is a static object by the static object determination unit 832 is difficult, the object detection device 8 may proceed to the processing of the final determination unit 833 after providing a notification that the determination of whether or not the target is a static object is difficult to outside the device. Further, when the determination is difficult, the object detection device 8 may return to the process of step ST1 of FIG. 2 and perform the determination in step ST3 of whether or not the target is a static object again.

The determination result acquired by the static object determination unit 832 is outputted to the final determination unit 833. In FIG. 2, the final determination unit 833 determines whether or not there is a possibility that the target collides with the radar device 1, using the determination result acquired by the static object determination unit 832 (step ST4). The series of processes of steps ST1 to ST3 of FIG. 2 is repeatedly performed in multiple cycles. For example, when the wave data acquisition unit 821, the velocity acquisition unit 822, the target data estimation unit 831, and the static object determination unit 832 perform the series of processes of steps ST1 to ST3 which is their respective processes in, for example, two or more cycles, the positions of the target at different times are acquired.

The static object determination unit 832 outputs the positions of the target at the different times, in addition to the determination result, to the final determination unit 833. The final determination unit 833 calculates the velocity vector of the target using the positions of the target at the different times, and estimates the direction of movement of the target using the velocity vector of the target, thereby determining whether or not there is a possibility that the target collides with the radar device 1 on the basis of the direction of movement of the target estimated thereby. A collision between the target and the radar device 1 means a collision between the vehicle in which the radar device 1 is mounted and the target.

When the series of processes of steps ST1 to ST3 is performed in three or more cycles, it is possible to calculate the acceleration of the target using the positions of the target at the different times. In this case, the final determination unit 833 can determine whether or not there is a possibility that the target collides with the radar device 1 using the acceleration of the target.

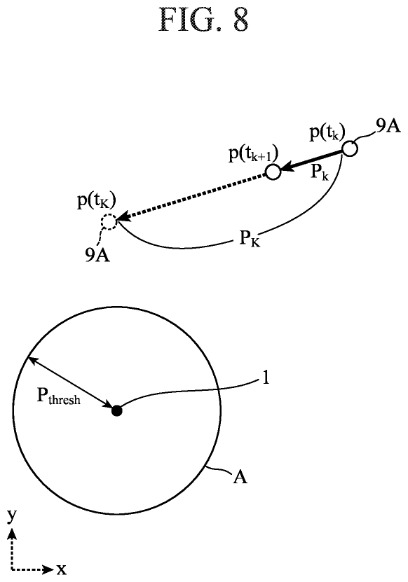

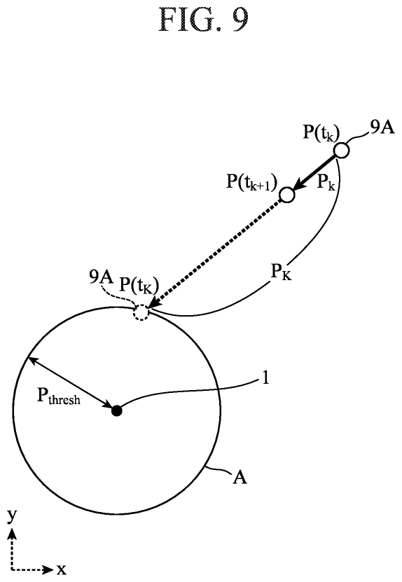

FIG. 7 is a flowchart showing the details of the process in step ST4 of FIG. 1, and shows the determination processing by the final determination unit 833. In FIG. 7, it is assumed that the series of processes of steps ST1 to ST3 of FIG. 2 is performed in two or more cycles, and to the final determination unit 833 are outputted γ_{obj} and data showing the positions of the target at the different times, as data showing the determination result, from the static object determination unit 832. Further, FIG. 8 is an outline diagram showing a positional relationship between the target and the radar device 1 when there is no possibility that they collide with each other. FIG. 9 is an outline diagram showing a positional relationship between the target and the radar device 1 when there is a possibility that they collide with each other.

In FIGS. 8 and 9, the target is the moving object 9A. When the position of the moving object 9A on which the static object determination at a time tₖ is performed is denoted by p(tₖ), the position of the moving object 9A on which the static object determination at the next time tₖ₊₁ is performed is denoted by p(tₖ₊₁). The final determination unit 833 estimates a velocity vector Pₖ of the moving object 9A as the direction of movement of the moving object 9A using the positions p(tₖ) and p(tₖ₊₁) (step ST1c). The final determination unit 833 determines a vector which is an extension of the velocity vector Pₖ to an arbitrary time t_{K} as a predicted line P_{K} of the movement of the moving object 9A, as shown in FIGS. 8 and 9.

Next, the final determination unit 833 sets up a collision prediction region A which is centered at the position of the radar device 1 and which has a radius equal to a distance threshold Pₜₕᵣₑₛₕ (step ST2c). For example, the distance threshold Pₜₕᵣₑₛₕ is set up in accordance with multiple parameters including the moving velocity or the acceleration of the radar device 1 and the relative distance between the radar device 1 and the target, and observation conditions.

The final determination unit 833 determines whether or not there is a possibility that the moving object 9A collides with the radar device 1 on the basis of whether the predicted line P_{K} crosses the collision prediction region A (step ST3c). For example, when the predicted line P_{K} is apart from the collision prediction region A, as shown in FIG. 8, the final determination unit 833 determines that there is no possibility that the moving object 9A collides with the radar device 1. When the predicted line P_{K} crosses the collision prediction region A, as shown in FIG. 9, the final determination unit 833 determines that there is a possibility that the moving object 9A collides with the radar device 1.

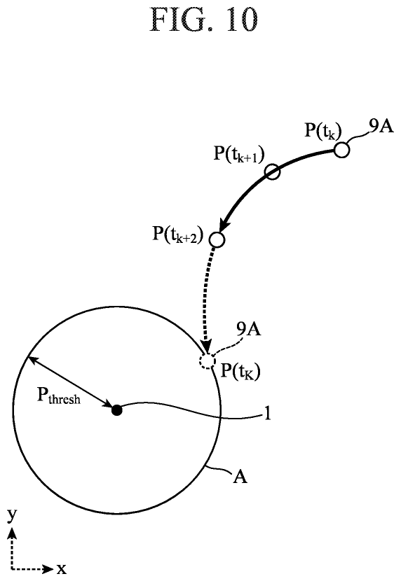

Although in FIGS. 8 and 9, a vector which is an extension of the velocity vector of the target to an arbitrary time t_{K} is defined as the predicted line P_{K}, the predicted line may be expressed by a multidimensional curve. FIG. 10 is an outline diagram showing a positional relationship between the prediction line which is a quadratic curve, and the radar device 1. The predicted line may be defined as a quadratic curve, as shown in FIG. 10.

For example, when predicting that the target is moving along a quadratically curved path using the position P(tₖ) of the target at an arbitrary time tₖ, the position P(tₖ₊₁) of the target at the next time tₖ₊₁, and the position P(tₖ₊₂) of the target at the further next time tₖ₊₂, which are outputted from the static object determination unit 832, the final determination unit 833 calculates the predicted line P_{K} which is a quadratic curve extended to the arbitrary time t_{K}. The final determination unit 833 determines whether or not there is a possibility that the target collides with the radar device 1 on the basis of whether the predicted line P_{K} crosses the collision prediction region A, like in the case of using the predicted line which is a one-dimensional vector.

Next, the final determination unit 833 outputs a result of the determination of whether or not there is a possibility of a collision with the target, and the static object determination result, as output data, to the output data storage unit 84. The output data stored in the output data storage unit 84 is outputted to, for example, a display device mounted in the vehicle. As a result, an occupant in the vehicle can recognize whether or not the target observed by the radar device 1 is a moving object and whether or not there is a possibility that the target collides with the vehicle on the basis of the output data displayed on the display device.

The object detection device 8 may be disposed separately from the radar device 1. In this case, the object detection device 8 acquires the wave data and the velocity data from the radar device 1 via a wired or wireless communication path. Further, the movable body in which the radar device 1 is mounted is not limited to a vehicle, and may be a railroad car, a ship, or an airplane.

Further, the antenna 2 may be at least two or more transmitting antennas and at least two or more receiving antennas which are arranged in a direction parallel or perpendicular to the direction of movement of the radar device 1. The transmitter 4 and the receiver 5 perform multiple-input multiple-output processing (MIMO processing) using signals transmitted by the transmitting antennas and signals received by the receiving antennas. As a result, because the opening diameter of the antenna 2 is virtually enlarged because of the two or more transmitting antennas and the two or more receiving antennas, the angular resolution of the angle of incidence of the reflection signal from the target to the radar device 1 is improved in the radar device 1.

A hardware configuration which implements the functions of the object detection device 8 is as follows.

The functions of the wave data acquisition unit 821, the velocity acquisition unit 822, the target data estimation unit 831, the static object determination unit 832, and the final determination unit 833, which the object detection device 8 includes, are implemented by a processing circuit. More specifically, the object detection device 8 includes a processing circuit which performs the processes of steps ST1 to ST4 shown in FIG. 2. The processing circuit may be either hardware for exclusive use or a central processing unit (CPU) which executes a program stored in a memory.

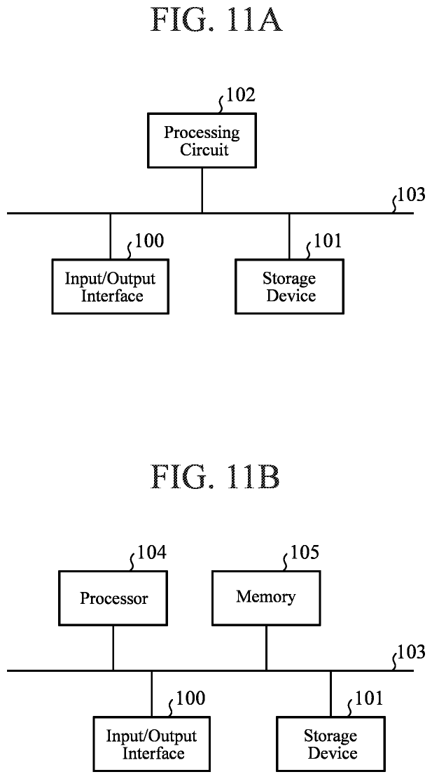

FIG. 11A is a block diagram showing a hardware configuration which implements the functions of the object detection device 8. FIG. 11B is a block diagram showing a hardware configuration which executes software which implements the functions of the object detection device 8. In FIGS. 11A and 11B, an input/output interface 100 relays data from the A/D converter 6 to the data storage unit 81, and relays data from the output data storage unit 84 to the not-illustrated display device, for example. The storage device 101 has a storage area which functions as the data storage unit 81 and the output data storage unit 84. Further, the components are connected to one another via a signal line 103.

In the case where the processing circuit is a circuit 102 shown in FIG. 11A that is hardware for exclusive use, the processing circuit 102 is, for example, a single circuit, a composite circuit, a programmable processor, a parallel programmable processor, an application specific integrated circuit (ASIC), a field programmable gate array (FPGA), or a combination of these circuits. The functions of the wave data acquisition unit 821, the velocity acquisition unit 822, the target data estimation unit 831, the static object determination unit 832, and the final determination unit 833, which the object detection device 8 includes, may be implemented by separate processing circuits, or these functions may be implemented collectively by a single processing circuit.

In the case where the processing circuit is a processor 104 shown in FIG. 11B, the functions of the wave data acquisition unit 821, the velocity acquisition unit 822, the target data estimation unit 831, the static object determination unit 832, and the final determination unit 833, which the object detection device 8 includes, are implemented by software, firmware, or a combination of software and firmware. The software or the firmware is described as programs and the programs are stored in a memory 105.

The processor 104 implements the functions of the wave data acquisition unit 821, the velocity acquisition unit 822, the target data estimation unit 831, the static object determination unit 832, and the final determination unit 833, which the object detection device 8 includes, by reading and executing the programs stored in the memory 105.

For example, the object detection device 8 includes the memory 105 for storing the programs in which the processes of steps ST1 to ST4 in the flowchart shown in FIG. 2 are performed as a result when the programs are executed by the processor 104. These programs cause a computer to perform the procedures or methods performed by the wave data acquisition unit 821, the velocity acquisition unit 822, the target data estimation unit 831, the static object determination unit 832, and the final determination unit 833. The memory 105 may be a computer readable storage medium in which the programs for causing the computer to function as the wave data acquisition unit 821, the velocity acquisition unit 822, the target data estimation unit 831, the static object determination unit 832, and the final determination unit 833 are stored.

The memory 105 is, for example, a non-volatile or volatile semiconductor memory, such as a random access memory (RAM), a read only memory (ROM), a flash memory, an erasable programmable read only memory (EPROM), or an electrically-EPROM (EEPROM), a magnetic disc, a flexible disc, an optical disc, a compact disc, a mini disc, a DVD, or the like.

Some of the functions of the wave data acquisition unit 821, the velocity acquisition unit 822, the target data estimation unit 831, the static object determination unit 832, and the final determination unit 833, which the object detection device 8 includes, may be implemented by hardware for exclusive use, and some of the functions may be implemented by software or firmware. For example, the functions of the wave data acquisition unit 821 and the velocity acquisition unit 822 are implemented by the processing circuit 102 which is hardware for exclusive use, and the functions of the target data estimation unit 831, the static object determination unit 832, and the final determination unit 833 are implemented by the processor 104's reading and executing programs stored in the memory 105. As mentioned above, the processing circuit can implement the above-mentioned functions by using hardware, software, firmware, or a combination of hardware, software, and firmware.

As mentioned above, the object detection device 8 according to Embodiment 1 includes: the wave data acquisition unit 821 to acquire the wave data; the velocity acquisition unit 822 to acquire the moving velocity of the radar device 1; the target data estimation unit 831 to estimate the relative distance between the radar device 1 and the target, the angle of incidence of a reflection signal from the target, and the first relative velocity between the radar device 1 and the target, using the wave data; and the static object determination unit 832 to estimate the second relative velocity between the target and the radar device 1 in a case where the target is a static object, on the basis of the moving velocity acquired by the velocity acquisition unit 822 and the relative distance and the angle of incidence which are estimated by the target data estimation unit 831, and to determine whether or not the target is a static object by comparing the first relative velocity and the second relative velocity. Because the wave data are data which the radar device 1 acquires by observing the target within the observation time period during which the speed resolution is smaller than the average moving velocity of moving objects, it is possible to estimate the second relative velocity in a case where the target is a static object, using the moving velocity of the radar device 1, the relative distance between the radar device 1 and the target, and the angle of incidence of the reflection signal from the target. As a result, even in a case where the target being observed by the radar device 1 includes a moving object and a static object having equal relative distances and equal angles of incidence, the object detection device 8 can determine whether or not the target is a static object.

Further, the object detection device 8 according to Embodiment 1 includes the final determination unit 833 to determine whether or not there is a possibility that the target collides with the radar device 1. As a result, the object detection device 8 can determine whether or not the target is a static object, and further determine whether or not there is a possibility that the target and the radar device 1 collide with each other.

In addition, the radar device 1 according to Embodiment 1 includes: the transmitter 4 to generate a transmission signal to be emitted to space; the receiver 5 to receive a signal resulting from the reflection of the transmission signal emitted to the space by the target; the speed meter 7 to measure the moving velocity of the radar device 1; and the object detection device 8. As a result, even in a case where the target being observed by the radar device 1 includes a moving object and a static object having equal relative distances and equal angles of incidence, the radar device 1 can determine whether or not the target is a static object and determine whether or not there is a possibility that the target and the radar device 1 collide with each other.

It is to be understood that changes can be made in an arbitrary component according to the embodiment, or an arbitrary component according to the embodiment can be omitted.

### INDUSTRIAL APPLICABILITY

The object detection device according to the present disclosure can be used for, for example, vehicle-mounted radar devices.

### REFERENCE SIGNS LIST

1 radar device, 2 antenna, 3 transmission/reception switch, 4 transmitter, 5 receiver, 6 A/D converter, 7 speed meter, 8 object detection device, 9A moving object, 9B static object, 81 data storage unit, 82 data acquisition unit, 83 signal processing unit, 84 output data storage unit, 821 wave data acquisition unit, 822 velocity acquisition unit, 831 target data estimation unit, 832 static object determination unit, and 833 final determination unit.

1. An object detection device comprising:
processing circuitry configured to
acquire wave data provided from a radar device that observes a target within an observation time period during which velocity resolution is less than an average moving velocity of a moving object;
acquire a moving velocity of the radar device;
estimate a relative distance between the radar device and the target, angle of incidence of a signal incident upon the radar device, the signal being emitted from the radar device and reflected by the target, and a first relative velocity between the radar device and the target, by using the wave data; and
estimate a second relative velocity between the radar device and the target in a case where the target is a static object, on a basis of the acquired moving velocity and the relative distance and the angle of incidence which have been estimated and configured to determine whether the target is a static object by comparing the first relative velocity and the second relative velocity.

2. The object detection device according to claim 1,
wherein the processing circuitry is configured to determine whether there is a possibility that the target collides with the radar device.

3. The object detection device according to claim 2,
wherein the processing circuitry repeatedly performs the processes in multiple cycles, and
estimates a moving direction of the target using a velocity vector of the target, the velocity vector being acquired through determination in the multiple cycles, and determines whether there is a possibility that the target collides with the radar device on the basis of the estimated moving direction of the target.

4. The object detection device according to claim 2,
wherein the processing circuitry repeatedly performs the processes at least two or more cycles, and
calculates a velocity vector of the target using positions of the target at different times, the positions being acquired through determination in the at least two or more cycles, and determines whether there is a possibility that the target collides with the radar device on a basis of a predicted line of movement of the target, the predicted line being estimated with a velocity vector of the target.

5. A radar device comprising:
a transmitter configured to generate a transmission signal to be emitted to space;
a receiver configured to receive a signal resulting from reflection of the transmission signal emitted to the space on a target;
a speed meter configured to measure a moving velocity of the radar device; and
the object detection device according to claim 1, the object detection device acquiring the wave data from the signal received by the receiver and acquiring the moving velocity from the speed meter.

6. The radar device according to claim 5, further comprising at least two or more transmitting antennas and at least two or more receiving antennas in a direction horizontal or perpendicular to a moving direction of the radar device, and
wherein the transmitter and the receiver perform multiple-input multiple-output processing using signals transmitted by the at least two or more transmitting antennas and signals received by the at least two or more receiving antennas.

7. An object detection method comprising:
acquiring wave data provided from a radar device that observes a target within an observation time period during which velocity resolution is less than an average moving velocity of a moving object;
acquiring a moving velocity of the radar device;
estimating a relative distance between the radar device and the target, angle of incidence of a signal incident upon the radar device, the signal being emitted from the radar device and reflected by the target, and a first relative velocity between the radar device and the target, by use of the wave data;
estimating a second relative velocity between the radar device and the target in a case where the target is a static object, on a basis of the acquired moving velocity and the relative distance and the angle of incidence which have been estimated; and
determining whether the target is a static object by comparing the first relative velocity and the second relative velocity.
